(19) United States
(12) Patent Application Publication
(10) Pub. No.: US 2022/0028007 A1
(43) Pub. Date: Jan. 27, 2022

(54) INSURANCE FEE SETTING SYSTEM

(71) Applicant: Toyota Jidosha Kabushiki Kaisha, Toyota-shi Aichi-ken (JP)

(72) Inventors: Masahiro Nishiyama, Toyota-shi (JP); Kenji Tsukagishi, Toyota-shi (JP); Takahisa Kaneko, Toyota-shi (JP)

(73) Assignee: Toyota Jidosha Kabushiki Kaisha, Toyota-shi Aichi-ken (JP)

(21) Appl. No.: 17/306,072

(22) Filed: May 3, 2021

(51) Int. Cl. G06Q 40/08; G06K 9/00; B60W 40/09

(52) U.S. Cl. CPC G06Q 40/08; G06K 9/00785; B60W 2540/30; B60W 40/09; G06K 9/00771

(57) ABSTRACT

An insurance fee setting system includes: a driving analysis server that is connected to a rear distance sensor, which is attached to a second vehicle, by a communication line, and that analyzes a driving state of a driver of a first vehicle that is a contract vehicle of an automobile insurance, based on detected data of the rear distance sensor; and an insurance fee setting server that sets an insurance fee of the automobile insurance in which the driver is under contract, based on the driving state of the driver input from the driving analysis server.

### CROSS-REFERENCE TO RELATED APPLICATION

This application claims priority to Japanese Patent Application No. 2020-124177 filed on Jul. 21, 2020, incorporated herein by reference in its entirety.

### BACKGROUND

### 1. Technical Field

The present disclosure relates to an automobile insurance fee setting system, and relates to a system for setting an automobile insurance fee contracted by a driver based on a driving state of the driver.

### 2. Description of Related Art

A method of setting an insurance fee of an automobile insurance based on a driving operation of a driver has been proposed. For example, Japanese Unexamined Patent Application Publication (Translation of PCT Application) No. 11-511581 (JP 11-511581 A) proposes a method of acquiring a driving operation state of a driver based on various sensors installed in a vehicle, and adding an extra fee to or discounting from the insurance fee based on the acquired driving operation state so as to set the insurance fee.

Further, Japanese Unexamined Patent Application Publication No. 2003-281375 (JP 2003-281375 A) proposes a method of receiving driving information of a driver of a vehicle, predicting a recommended driving response for the driver, warning the driver of a driving state that is predicted to lead to an accident of the driver, and increasing an insurance fee if the response of the driver to the warning is poor and decreasing the insurance fee if the response is good.

### SUMMARY

By the way, in the prior art described in JP 11-511581 A and JP 2003-281375 A, since various sensors attached to the vehicle in which the driver is driving are used to evaluate the driving operation mode of the driver, there are cases in which the prior art cannot be applied to vehicles that are not equipped with the various sensors. Further, for example, when the driver is driving the vehicle in a state in which a part of the vehicle has broken down, the sensor cannot grasp a failure state, and it is difficult to objectively determine whether the driver is safely driving the vehicle.

Thus, an object of the present disclosure is to comprehensively and objectively determine whether a driver is safely driving the vehicle and set an insurance fee.

An insurance fee setting system that is an insurance fee setting system of an automobile insurance, the insurance fee setting system including: a driving analysis server that is connected to, by a communication line, a camera or a sensor attached to a vehicle or a facility, and that analyzes a driving state of a driver of another vehicle that is a contract vehicle of the automobile insurance, based on one or both of an image captured by the camera and detection data of the sensor; and an insurance fee setting server that is connected to the driving analysis server by a communication line, and that sets an insurance fee of the automobile insurance in which the driver is under contract, based on a driving state of the driver input from the driving analysis server.

In this way, the driving state of the other vehicle that is a contract vehicle of the automobile insurance is detected based on the image captured by the camera attached to the vehicle or the facility or based on the detection data of the sensor. Thus, it is possible to comprehensively and objectively determine whether the driver is safely driving the other vehicle. The insurance fee can be set accurately based on such a comprehensive and objective determination of the driving state.

In the insurance fee setting system of the present disclosure, the driving analysis server may analyze a vehicle state of the other vehicle based on an image captured by the camera, and the insurance fee setting server may set the insurance fee of the automobile insurance based on the vehicle state of the other vehicle input from the driving analysis server.

In this way, the vehicle state of the other vehicle is confirmed by the camera attached to the vehicle or the facility. Thus, a failure of the other vehicle, etc. that cannot be detected by the sensor of the other vehicle can be detected and applied to setting the insurance fee. For example, when it is assumed that the driver is driving the vehicle in a state in which the vehicle is failing or is damaged, it may be determined that the driver is not safely driving the vehicle and the insurance fee may be set at an increased amount.

In the insurance fee setting system of the present disclosure, the driving analysis server may be connected to the other vehicle by a communication line, and may transmit the analyzed driving state of the driver of the other vehicle to the other vehicle.

As a result, when the driver of the other vehicle is not driving safely, a warning can be sent to the driver of the other vehicle to encourage safe driving. Further, it is possible to reduce traffic accidents and suppress insurance payments.

In the insurance fee setting system of the present disclosure, the driving analysis server may be connected to the other vehicle by a communication line, and may transmit the analyzed vehicle state of the other vehicle to the other vehicle.

This makes it possible to inform the driver of the other vehicle of the vehicle state of the other vehicle and warn the driver of the other vehicle to maintain the other vehicle in a state appropriate for safe driving. Further, it is possible to reduce traffic accidents and suppress insurance payments.

In the insurance fee setting system of the present disclosure, the vehicle may be an automobile traveling in front of the other vehicle, the camera may be a rear camera attached to the automobile, and the sensor may be a rear distance sensor of the automobile.

This allows the camera of the automobile in front to identify other vehicle behind and measure the inter-vehicle distance with the distance sensor. When the vehicle behind is not being driven safely, the driving state can be accurately acquired and analyzed. The insurance fee of the other vehicle can be increased based on the analyzed driving state.

In the insurance fee setting system of the present disclosure, the camera may be a surveillance camera attached to the facility, and the driving analysis server may analyze the driving state of the driver of the other vehicle and the vehicle state of the other vehicle based on an image of the surveillance camera, and output the analyzed driving state of the driver of the other vehicle and the analyzed vehicle state of the other vehicle to the insurance fee setting server.

In this way, the driving state of the driver of the other vehicle and the vehicle state of the other vehicle are analyzed based on the image of the surveillance camera provided along the road. Thus, even when data from the rear camera and the sensor of the automobile cannot be acquired, the driving state of the other vehicle can be analyzed and the vehicle state of the other vehicle can be detected.

Thus, an object of the present disclosure is to comprehensively and objectively determine whether a driver is safely driving the vehicle and set an insurance fee.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a system diagram showing a configuration of an insurance fee setting system according to an embodiment;

FIG. 2 is a diagram showing a data structure of an insurance fee database stored in a memory of an insurance fee setting server; and

FIG. 3 is an image taken by a rear camera of a second vehicle.

### DETAILED DESCRIPTION OF EMBODIMENTS

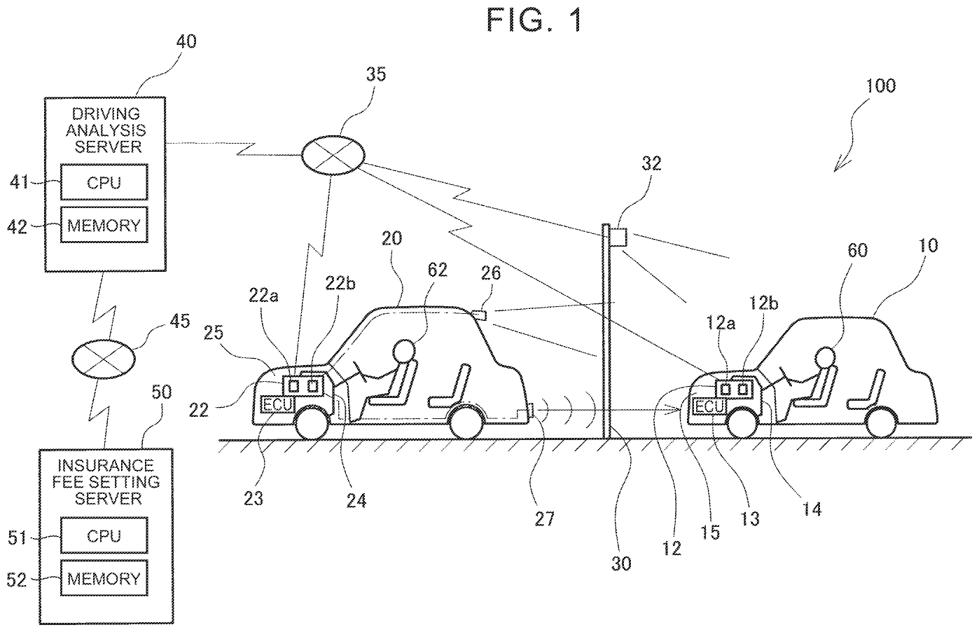

Hereinafter, an insurance fee setting system 100 of automobile insurance of the embodiment will be described with reference to the drawings. As shown in FIG. 1, the insurance fee setting system 100 includes a driving analysis server 40 and an insurance fee setting server 50. The driving analysis server 40 is connected to a camera or a sensor, which is attached to a vehicle or a facility, by a communication line, and analyzes a driving state of a driver of another vehicle that is a contract vehicle of the automobile insurance, based on one or both of an image captured by the camera and detection data of the sensor. Hereinafter, the other vehicle that is the contract vehicle of automobile insurance will be referred to as a first vehicle 10, and a vehicle to which the camera or the sensor is attached will be referred to as a second vehicle 20. The first vehicle 10 and the second vehicle 20 are both automobiles traveling on a road.

The first vehicle 10 is a contract vehicle of the automobile insurance, and is driven by a driver 60 who is an insurance contractor. In a front compartment 15 in which a power unit 14 and an ECU 13 are stored, the first vehicle 10 has a communication device 12 connected to the driving analysis server 40 by a communication line 35. The communication device 12 is a computer internally including a CPU 12a that performs information processing and a memory 12b that stores an operation program and data. Further, the ECU 13 is connected to the communication device 12.

The second vehicle 20 is a vehicle different from the first vehicle 10, travels in front of the first vehicle 10, and is driven by a driver 62. In the second vehicle 20, a rear camera 26 that captures an image of an area behind the second vehicle 20 is attached to an upper side of the rear of the second vehicle 20. Further, in the vicinity of a rear bumper, a rear distance sensor 27 that detects a distance between the second vehicle 20 and a rear vehicle or a rear obstacle and that outputs detection data is attached. The rear camera 26 and the rear distance sensor 27 are connected to a communication device 22. The communication device 22 is connected to the driving analysis server 40 by a communication line 35. Thus, the rear camera 26 and the rear distance sensor 27 are connected to the driving analysis server 40 via the communication device 22 and the communication line 35.

The communication device 22 is a computer internally including a CPU 22a that performs information processing and a memory 22b that stores an operation program and data. The communication device 22 stores an image input from the rear camera 26 and distance data input from the rear distance sensor 27, in the memory 22b. Further, the communication device 22 is installed in a front compartment 25 of the second vehicle 20 with a power unit 24 and an ECU 23, and the ECU 23 is connected to the communication device 22.

A surveillance tower 30 is a tower built along a road, and a surveillance camera 32 that captures an image of a vehicle traveling on the road is attached to an upper end thereof. Since the surveillance camera 32 is disposed so as to capture an image of a vehicle traveling toward the surveillance camera 32, it is possible to acquire an image of a driver's face through a windshield together with an image of the vehicle. The surveillance camera 32 may be attached to other facility or structures such as a pedestrian bridge or a building along a road, and is not limited to be attached to the surveillance tower 30.

The driving analysis server 40 is a computer internally including a CPU 41 that is a processor that processes information, and a memory 42 that stores programs, operation data, image data used for image analysis, and the like. The driving analysis server 40 is connected to the communication device 12 of the first vehicle 10, the communication device 22 of the second vehicle 20, and the surveillance camera 32, via the communication line 35. Further, the driving analysis server 40 is connected to the rear camera 26 and the rear distance sensor 27 of the second vehicle 20 via the communication line 35 and the communication device 22.

The driving analysis server 40 analyzes the driving state of the driver 60 of the first vehicle 10 based on an image from the rear camera 26 of the second vehicle 20, data from the rear distance sensor 27, or an image from the surveillance camera 32, and outputs the analysis to the insurance fee setting server 50. Further, the driving analysis server 40 analyzes the vehicle state of the first vehicle 10 such as whether the first vehicle 10 is damaged or broken based on the image captured by the rear camera 26 of the second vehicle 20, and outputs the analysis to the insurance fee setting server 50. Further, the driving analysis server 40 transmits the analyzed driving state of the driver 60 of the first vehicle 10 to the communication device 12 of the first vehicle 10. Further, the driving analysis server 40 transmits the analyzed vehicle state of the first vehicle 10 to the communication device 12 of the first vehicle 10. Further, the driving analysis server 40 analyzes the driving state of the driver 60 of the first vehicle 10 and the vehicle state of the first vehicle 10 based on an image of the surveillance camera 32, and outputs the analyzed driving state of the driver 60 of the first vehicle 10 and the analyzed vehicle state of the first vehicle 10 to the insurance fee setting server 50.

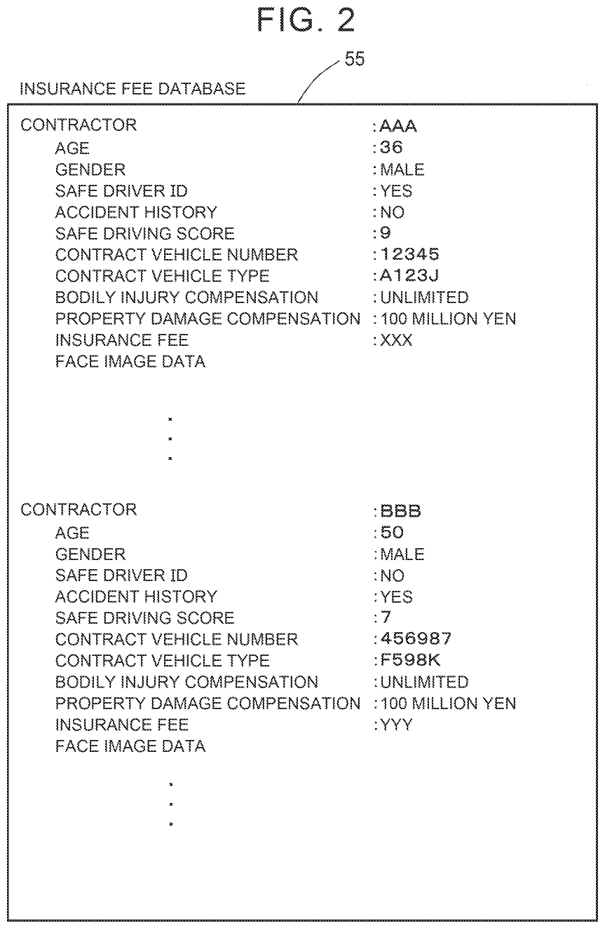

The insurance fee setting server 50 is connected to the driving analysis server 40 by a communication line 45. Similar to the driving analysis server 40, the insurance fee setting server 50 is a computer internally including a CPU 51 that is a processor that processes information, and a memory 52 that stores a program, operation data, and a database to be referred to when calculating insurance fees, and the like. The insurance fee setting server 50 sets the insurance fee of the automobile insurance contracted by the driver 60 based on the driving state of the driver 60 of the first vehicle 10 input from the driving analysis server 40. Further, the insurance fee setting server 50 sets the insurance fee of the automobile insurance based on the vehicle state of the first vehicle 10 input from the driving analysis server 40. An insurance fee database 55 as shown in FIG. 2 is stored in the memory 52 of the insurance fee setting server 50.

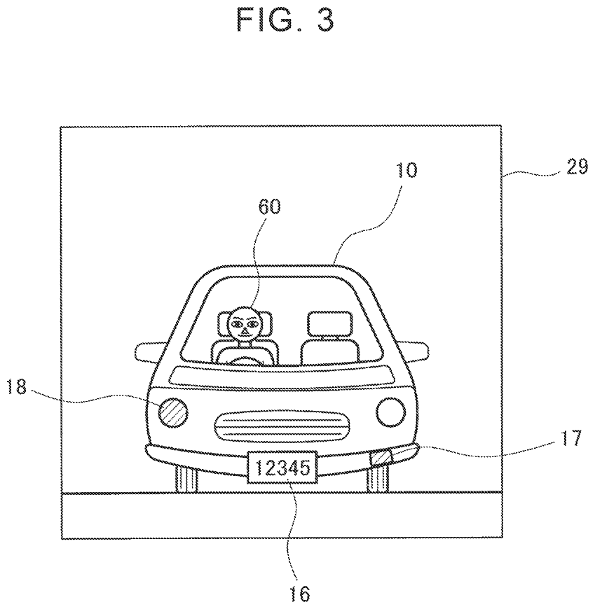

The insurance fee database 55 is a database that stores, in association with each other, data of a contractor of automobile insurance such as a name, age, gender, presence/absence of a safe driver ID, presence/absence of accident history, a safe driving score at the time of contract, a contract vehicle number, a contract vehicle type, a bodily injury compensation amount, a property damage compensation amount, and an insurance fee, and face image data of the contractor. Here, the contract vehicle number is, for example, the number of a license plate 16 shown in FIG. 3. The safe driving score is an index showing a driving safety level of the contractor that is diagnosed using a predetermined driving diagnosis software or a driving diagnosis application at the time of contract. In the safe driving score, the full score is 10 points, and the higher the score, the higher the degree of driving safety is indicated. The safe driver ID is, for example, a case in which it is indicated on a driver's license with a gold band that there have been no accidents or violations over the past few years.

According to the insurance fee database 55 shown in FIG. 2, for example, a contractor AAA is a 36-year-old man, who has a safe driver ID (indicated “YES”), has no accident history (indicated “NO”), and has a safe driving score of 9 points, in which a vehicle number is “12345”, a contract vehicle type is “A123J”, a bodily injury compensation is unlimited, a property damage compensation is 100 million yen, and an insurance fee is XXX. In addition, a contractor BBB has no safe driver ID (indicated “NO”), has an accident history (indicated “YES”), and has a safe driving score of 7 points. Since the property damage compensation amount is the same as that of the contractor AAA, the insurance fee of the contractor BBB is higher than the insurance fee of the contractor AAA.

Next, the operation of the insurance fee setting system 100 configured as above will be described. The second vehicle 20 is traveling on the road. The rear camera 26 captures an image of an area behind the second vehicle 20 and inputs the image to the communication device 22. The communication device 22 stores the image data that is from the present time to before a predetermined time, and that is input from the rear camera 26, in the memory 22b. Further, the communication device 22 measures the distance to the vehicle traveling behind with the rear distance sensor 27, and outputs measurement data to the communication device 22. The communication device 22 stores the distance data that is from the present time to before a predetermined time, and that is input from the rear distance sensor 27, in the memory 22b. Further, the communication device 22 acquires a traveling speed of the second vehicle 20 from the ECU 23.

When the first vehicle 10 is traveling behind the second vehicle 20, the rear distance sensor 27 detects an inter-vehicle distance between the second vehicle 20 and the first vehicle 10 and outputs the inter-vehicle distance to the communication device 22. When the inter-vehicle distance detected by the rear distance sensor 27 becomes substantially constant, the communication device 22 transmits to the driving analysis server 40, an image 29 that is shown in FIG. 3 and that is captured by the rear camera 26, inter-vehicle distance data, and traveling speed data of the second vehicle 20. As shown in FIG. 3, the image 29 is an image of the first vehicle 10 taken from the front, and includes an image of the license plate 16 of the first vehicle 10 and an image of the driver 60 of the first vehicle 10.

The driving analysis server 40 determines whether the first vehicle 10 is traveling while maintaining a sufficient inter-vehicle distance with respect to the speed, based on the traveling speed data and the inter-vehicle distance data transmitted from the communication device 22. For example, if the inter-vehicle distance is about 80 to 100 m when traveling at 80 km/h, the driving analysis server 40 determines that the first vehicle 10 is safely traveling while maintaining an appropriate inter-vehicle distance, and transmits the image data of the image 29 captured by the rear camera 26 to the insurance fee setting server 50, together with a safe driving signal.

The insurance fee setting server 50 extracts numbers and symbols of the license plate 16 from the data of the image 29 input from the driving analysis server 40, and searches whether there is a corresponding contract vehicle number stored in the insurance fee database 55. Then, when the numbers and symbols of the license plate 16 and the contract vehicle number stored in the insurance fee database 55 match, the first vehicle 10 is identified as a vehicle subject to the automobile insurance contract. In this case, the insurance fee setting server 50 extracts the image of the face of the driver 60 from the image 29, and uses a method such as pattern matching to analyze if the image matches with the face image data stored in association with the above contract vehicle number. Then, when the face image extracted from the image 29 and the face image stored in the insurance fee database 55 match, it is specified that the person driving the first vehicle 10 is the contractor AAA.

Next, the insurance fee setting server 50 discounts the insurance fee based on the safe driving signal input from the driving analysis server 40. For example, the insurance fee setting server 50 calculates the insurance fee on the assumption that the safe driving score is increased by just 0.1 point. Then, the insurance fee setting server 50 discounts the insurance fee by just the difference between the insurance fee calculated at the time of the next insurance fee charge and the current insurance fee, and charge the contractor AAA.

In contrast, when the second vehicle 20 is traveling at a speed of 80 km/h and the inter-vehicle distance between the second vehicle 20 and the first vehicle 10 is about 10 m, the driving analysis server 40 determines that the first vehicle 10 is not traveling safely, and transmits the image data of the image 29 captured by the rear camera 26 to the insurance fee setting server 50, together with a driving warning signal.

When the insurance fee setting server 50 identifies that the first vehicle 10 is the insurance contract vehicle and the driving party is the contractor AAA in the same manner as described above, the insurance fee setting server 50 increases the insurance fee based on the driving warning signal input from the driving analysis server 40. For example, the insurance fee setting server 50 calculates the insurance fee on the assumption that the safe driving score is decreased by just 0.5 points. Then, the insurance fee setting server 50 charges the insurance fee by increasing the insurance fee by just the difference between the insurance fee calculated at the time of the next insurance fee charge and the current insurance fee.

Further, the driving analysis server 40 analyzes the image 29 input from the rear camera 26 attached to the second vehicle 20, and as shown in FIG. 3, when a headlight 18 of the first vehicle 10 is not turned on due to a failure, or when a dent of a bumper 17 is not repaired, the driving analysis server 40 determines that the vehicle state of the first vehicle 10 is not suitable for safe driving, and outputs a vehicle state failure signal to the insurance fee setting server 50. The vehicle state failure signal includes failure degree data indicating the degree of failure. When the vehicle state failure signal is input from the driving analysis server 40, the insurance fee setting server 50 increases the insurance fee based on the defect degree data included in the vehicle state failure signal.

Further, when the insurance fee setting server 50 receives the driving warning signal from the driving analysis server 40, the insurance fee setting server 50 transmits the vehicle number of the first vehicle 10 to the driving analysis server 40. When the driving analysis server 40 receives the vehicle number data from the insurance fee setting server 50, the driving analysis server 40 identifies the first vehicle 10, and transmits to the communication device 12 of the first vehicle 10, the vehicle speed of the second vehicle 20 and data of the inter-vehicle distance between the first vehicle 10 and the second vehicle 20. The data is displayed on a display of a car navigation system of the first vehicle 10, etc., and becomes a warning to the driver 60 who is driving the first vehicle 10 that the current driving state is not safe and that the driver should drive safely.

After that, the communication device 22 of the second vehicle 20 transmits to the driving analysis server 40, the inter-vehicle distance data measured by the rear distance sensor 27, the vehicle speed data acquired from the ECU 23, and the image 29 that is shown in FIG. 3 and that is captured by the rear camera 26.

If driving is not improved, the driving analysis server 40 transmits the driving warning signal to the insurance fee setting server 50 again. Then, the insurance fee setting server 50 further increases the insurance fee.

In the above description, when the inter-vehicle distance detected by the rear distance sensor 27 becomes substantially constant, the communication device 22 transmits to the driving analysis server 40, an image 29 that is shown in FIG. 3 and that is captured by the rear camera 26, inter-vehicle distance data, and traveling speed data of the second vehicle 20. However, the communication device 22 is not limited to this. For example, when the inter-vehicle distance detected by the rear distance sensor 27 becomes equal to or less than a predetermined distance, the communication device 22 may capture an image with the rear camera 26 and transmit the inter-vehicle distance data and the traveling speed data of the second vehicle 20 to the driving analysis server 40. Here, the predetermined distance may be, for example, a distance in which a numerical part of the km/h of the vehicle speed input from the ECU 23 is in meters. For example, when the vehicle speed is 60 km/h, the predetermined distance is 60 m. When the inter-vehicle distance becomes 60 m or less, the driving analysis server 40 determines that the first vehicle 10 is not driving safely and outputs the driving warning signal to the insurance fee setting server 50.

Further, when the degree of decrease in the inter-vehicle distance detected by the rear distance sensor 27 is larger than a predetermined value, the communication device 22 may capture an image with the rear camera 26, and the inter-vehicle distance data and the traveling speed data of the second vehicle 20 may be transmitted to the driving analysis server 40. As described above, when the degree of decrease in the inter-vehicle distance is large, there is a possibility that the first vehicle 10 traveling behind the vehicle is approaching and performing unsafe driving, such as tailgating. In this case, the driving analysis server 40 determines that the first vehicle 10 is not driving safely and outputs the driving warning signal to the insurance fee setting server 50.

For example, when a state in which the inter-vehicle distance detected by the rear distance sensor 27 is equal to or more than a predetermined distance is continues for a predetermined period, the communication device 22 may capture an image with the rear camera 26 and transmit the inter-vehicle distance data and the traveling speed data of the second vehicle 20 to the driving analysis server 40. In this case, the driving analysis server 40 determines that the first vehicle 10 is driving safely and outputs the safe driving signal to the insurance fee setting server 50.

In the above description, the driving analysis server 40 has been described as analyzing the driving state of the driver 60 of the first vehicle 10 based on the inter-vehicle distance data detected by the rear distance sensor 27 attached to the second vehicle 20. However, the driving analysis server 40 is not limited to this, and may analyze the driving state of the driver 60 based on the image captured by the rear camera 26 attached to the second vehicle 20.

For example, the rear camera 26 may capture an image of an area behind the second vehicle 20 so as to include a structure such as a post of a guide rail, etc. that is installed at equal intervals between the first vehicle 10 traveling behind the second vehicle 20 and the second vehicle 20. The driving analysis server 40 may calculate the inter-vehicle distance based on the intervals and number of the structures included in the captured image, and determine the driving state of the driver 60 of the first vehicle 10.

Further, the driving analysis server 40 may detect right-left swaying of the first vehicle 10 that is being captured, based on a moving image captured by the rear camera 26. If there is no swaying, the driving analysis server 40 may determine that the driver 60 of the first vehicle 10 is driving safely, and output the safe driving signal to the insurance fee setting server 50. If there is a large degree of swaying, the driving analysis server 40 may output the driving warning signal to the insurance fee setting server 50.

At this time, when there is no right-left swaying and the inter-vehicle distance data detected by the rear distance sensor 27 attached to the second vehicle 20 is a distance appropriate for safe driving, the driving analysis server 40 may output the safe driving signal to the insurance fee setting server 50. When there is a large degree of right-left swaying or when the inter-vehicle distance is not a distance appropriate for safe driving, the driving analysis server 40 may output the driving warning signal to the insurance fee setting server 50.

Further, the identification of the first vehicle 10 has been described as being performed by the insurance fee setting server 50 based on the image of the license plate 16 in the image of the rear camera 26 attached to the second vehicle 20. However, the identification of the first vehicle 10 is not limited to this. For example, the driving analysis server 40 has a registered vehicle database in which vehicles for analyzing the driving state are registered, the first vehicle 10 is registered in the registered vehicle database, and the driving analysis server 40 can communicate with the communication device 12 installed on the first vehicle 10. In such a case, the driving analysis server 40 identifies the first vehicle 10 by communicating with the communication device 12 of the first vehicle 10. Then, the driving analysis server 40 may output the vehicle number of the specified first vehicle 10 to the insurance fee setting server 50, and the insurance fee setting server 50 may refer to the insurance fee database 55 shown in FIG. 2 to determine whether the first vehicle 10 is the contract vehicle of the automobile insurance.

Further, when the driving analysis server 40 determines that the vehicle state of the first vehicle 10 is not appropriate for safe driving based on the image of the rear camera 26 attached to the second vehicle 20, the driving analysis server 40 can transmit text data indicating a damaged part with the data of the image 29 of the first vehicle 10, and the driving analysis server 40 can warn the driver 60 of the first vehicle 10 to put the first vehicle 10 in a state appropriate for safe driving.

Further, the driving analysis server 40 may acquire the image from the surveillance camera 32 installed on the surveillance tower 30, analyze the image acquired from the surveillance camera 32 to detect the inter-vehicle distance between the first vehicle 10 and the second vehicle 20 and the vehicle state of the first vehicle 10 so as to analyze the driving state of the driver 60 of the first vehicle 10 and the vehicle state of the first vehicle 10, and output the analyzed driving state of the driver 60 of the first vehicle 10 and the analyzed vehicle state of the first vehicle 10 to the insurance fee setting server 50.

In this case, the driving analysis server 40 may calculate the inter-vehicle distance based on the image in which the first vehicle 10 and the second vehicle 20 are simultaneously captured by the surveillance camera 32, or the surveillance camera 32 may capture two photographs of the first vehicle 10 within a short amount of time and the driving analysis server 40 may calculate the vehicle speed of the first vehicle 10 from a moving distance of the first vehicle 10. Further, since the surveillance camera 32 can capture the first vehicle 10 from the front of the first vehicle 10, the vehicle state analysis of whether the first vehicle 10 has a failure or damage may be performed based on the image captured by the surveillance camera 32. Further, the driving analysis server 40 may acquire an image including an image of the license plate 16 and an image of the face of the driver 60 from the surveillance camera 32 as shown in the image 29 of FIG. 3, and may identify the first vehicle 10 and the driver 60 with the insurance fee setting server 50 by transferring the image to the insurance fee setting server 50.

As described above, the insurance fee setting system 100 of the embodiment detects the driving state of the first vehicle 10, based on the image captured by the rear camera 26 attached to the second vehicle 20 different from the first vehicle 10 that is the contract vehicle of the automobile insurance and the inter-vehicle distance detected by the rear distance sensor 27, and the like. Thus, it is possible to determine comprehensively and objectively whether the driver 60 is safely driving the first vehicle 10. The insurance fee can be set accurately based on such a comprehensive and objective determination of the driving state.

Further, since the insurance fee setting system 100 of the embodiment confirms the vehicle state of the first vehicle 10 with the rear camera 26 attached to the second vehicle 20, it is possible to detect a failure, etc. of the first vehicle 10 that cannot be detected by a sensor of the first vehicle 10, and the detected failure can be applied to setting the insurance fee. For example, when the driver 60 is driving the first vehicle 10 while a part of the first vehicle 10 is failing, the insurance fee setting system 100 of the embodiment can determine that the driver 60 is not safely driving the first vehicle 10 and set the insurance fee at an increased amount.

Further, since the insurance fee setting system 100 of the embodiment transmits the analyzed driving state of the driver 60 of the first vehicle 10 to the first vehicle 10, the driver 60 who is driving the first vehicle 10 can be warned that the driving state is not safe and that the driver 60 should drive safely. As a result, it is possible to reduce traffic accidents and suppress insurance payments.

Further, since the insurance fee setting system 100 of the embodiment transmits the vehicle state of the first vehicle 10 to the first vehicle 10, the driver 60 of the first vehicle 10 can be warned to put the first vehicle 10 in a state appropriate for safe driving. As a result, it is possible to reduce traffic accidents and suppress insurance payments.

Further, the insurance fee setting system 100 of the embodiment detects the inter-vehicle distance between the first vehicle 10 and the second vehicle 20 and analyzes the vehicle state of the first vehicle 10 with the surveillance camera 32 attached to the surveillance tower 30 provided along the road. Thus, even when data from the rear camera 26 and the rear distance sensor 27 of the second vehicle 20 cannot be acquired, the driving state and the vehicle state of the first vehicle 10 can be analyzed, and the insurance fee can be discounted or increased.

What is claimed is:

1. An insurance fee setting system of an automobile insurance, the insurance fee setting system comprising:
a driving analysis server that is connected to, by a communication line, a camera or a sensor attached to a vehicle or a facility, and that analyzes a driving state of a driver of another vehicle that is a contract vehicle of the automobile insurance, based on one or both of an image captured by the camera and detection data of the sensor; and
an insurance fee setting server that is connected to the driving analysis server by a communication line, and that sets an insurance fee of the automobile insurance in which the driver is under contract, based on a driving state of the driver input from the driving analysis server.

2. The insurance fee setting system according to claim 1, wherein:
the driving analysis server analyzes a vehicle state of the other vehicle based on the image captured by the camera; and
the insurance fee setting server sets the insurance fee of the automobile insurance based on the vehicle state of the other vehicle input from the driving analysis server.

3. The insurance fee setting system according to claim 1, wherein the driving analysis server is connected to the other vehicle by a communication line, and transmits the analyzed driving state of the driver of the other vehicle to the other vehicle.

4. The insurance fee setting system according to claim 2, wherein the driving analysis server is connected to the other vehicle by a communication line, and transmits the analyzed vehicle state of the other vehicle to the other vehicle.

5. The insurance fee setting system according to claim 1, wherein:
the vehicle is an automobile traveling in front of the other vehicle; and
the camera is a rear camera attached to the automobile, and the sensor is a rear distance sensor of the automobile.

6. The insurance fee setting system according to claim 1, wherein:
the camera is a surveillance camera attached to the facility; and
the driving analysis server analyzes the driving state of the driver of the other vehicle and the vehicle state of the other vehicle based on the image of the surveillance camera, and outputs the analyzed driving state of the driver of the other vehicle and the analyzed vehicle state of the other vehicle to the insurance fee setting server.
